(19) United States
(12) Patent Application Publication
(10) Pub. No.: US 2001/0018299 A1
(43) Pub. Date: Aug. 30, 2001

(54) Electrical connector and method of preparing same for soldering

(76) Inventor: Cheng Te Lin, Taipei Hsien (TW)

Correspondence Address: Robert J. Zeitler, MOLEX INCORPORATED, 2222 Wellington Court, Lisle, IL, 60532, US

(21) Appl. No.: 09/753,175

(22) Filed: Jan. 2, 2001

(30) Foreign Application Priority Data
Jan. 3, 2000 (TW) 89200045

(51) Int. Cl. H01R 9/24; H01R 13/02

(52) U.S. Cl. 439/886

(57) ABSTRACT

An electrical connector includes an outer shell having grounding legs provided thereon. The outer shell and grounding legs are preferably made of stainless steel. The grounding legs are treated to form a coarse surface, and then a metal coating is applied thereon such that a coarse metal surface is provided. Alternatively, a metal coating is applied to the grounding legs, and then treated to form the coarse surface. The coarse surface enables easy soldering of the grounding legs with a printed circuit board. The coarse surface can be formed on the entire outer shell if desired.

### FIELD OF THE INVENTION

The present invention relates to an electrical connector and a method of preparing the electrical connector for soldering to a printed circuit board.

### BACKGROUND OF THE INVENTION

Prior art electrical connectors, such as a USB connector, are generally formed of an electrically conductive outer shell, an electrically insulative body housed within the outer shell and a set of terminals which are provided on the body and extend outwardly from the outer shell. The outer shell protects the electrically insulative body against electromagnetic interference. The outer shell includes inwardly protruding retaining spring strips for securing a mating connector thereto. The outer shell also includes grounding legs which extend therefrom. In use, the grounding legs are soldered, preferably with a tin solder, to a printed circuit board.

It is important to take into consideration resiliency and solderability of the material when choosing the material for the outer shell. Phosphor bronze, beryllium copper or copper alloy are commonly used in prior art connectors. These materials, however, are expensive and the have low resiliency. In addition, these materials must be electroplated with a metal protective layer to protect against oxidation.

Stainless steel is a good material choice for making such an electrically conductive outer shell due to its low cost and high anti-oxidation properties. Stainless steel, however, is not practical for soldering, and in particular tin soldering. The present invention provides an electrical connector which has an outer shell formed of stainless steel that has been prepared to enable the grounding legs to be soldered, preferably with a tin solder, to the printed circuit board. Other features and advantages of the present invention will become apparent upon a reading of the attached specification, in combination with a study of the drawings.

### SUMMARY OF THE INVENTION

A general object of the present invention is to provide a novel stainless steel electrical connector which has been treated to enable the electrical connector to be soldered to a printed circuit board.

Another general object of the present invention is to provide a method of preparing an electrical connector for soldering to a printed circuit board.

An object of the present invention is to provide a novel electrical connector which can be manufactured from a lost-cost material and has high anti-oxidation properties.

Another object of the present invention is to provide a novel electrical connector which has high resiliency and high insertion durability.

Briefly and in accordance with the foregoing, the present invention provides an electrical connector which includes an electrically conductive outer shell which includes grounding legs. The outer shell and grounding legs are made of stainless steel. A coarse surface is formed on the grounding legs, preferably by acid cleaning, and then a metal coating is applied thereon, preferably by electroplating, such that a coarse metal surface is provided. Alternatively, the grounding legs may have a metal coating applied thereon, preferably by electroplating, and then treated to form the coarse surface, preferably by acid cleaning. The coarse surface enables easy soldering of the grounding legs with a printed circuit board. The metal coating can preferably be formed of at least one of nickel, tin, and lead. The coarse surface can be formed on the entire outer shell if desired.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a first embodiment of an electrical connector which incorporates the features of the invention;

FIG. 2 is a front plan view of the electrical connector of FIG. 1;

FIG. 3 is an enlarged cross-sectional of a portion of the electrical connector shown in FIGS. 1 and 2; and

FIG. 4 is a perspective view of a second embodiment of an electrical connector which incorporates the features of the invention.

### DETAILED DESCRIPTION OF THE PREFERRED EMBODIMENT

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

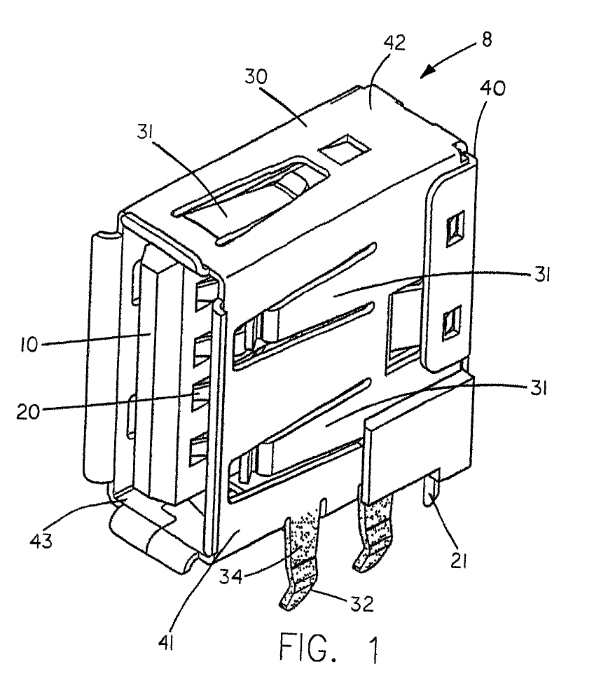

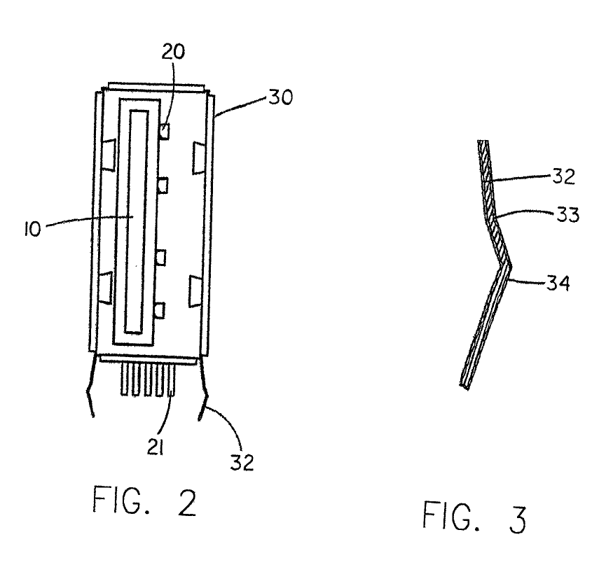

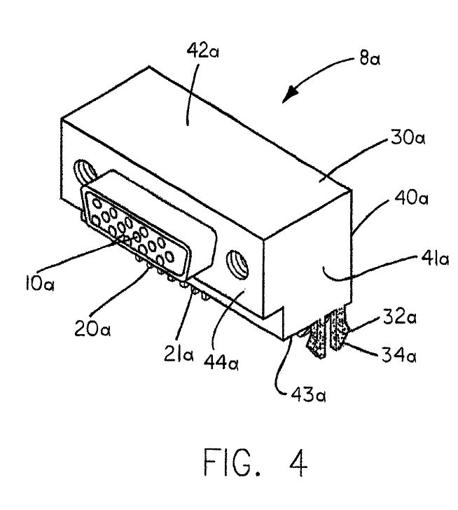

The present invention provides a novel shielded electrical connector 8, 8a and a method of preparing the electrical connector 8, 8a for soldering with a printed circuit board (not shown). A first embodiment of the electrical connector 8 is shown in FIGS. 1-3. A second embodiment of the electrical connector 8a is shown in FIG. 4.

As shown in FIGS. 1-3, the first embodiment of the electrical connector 8 generally includes an electrically conductive outer shell 30, an electrically insulative body 10 which is substantially surrounded by the outer shell 30, and a set of metal terminals 20 which are mounted on the electrically insulative body 10 and extend outwardly from the outer shell 30.

The outer shell 30 includes a rear wall 40, a pair of side walls 41, a top wall 42 and a bottom wall 43. The front side of the outer shell 30 is open so that a mating electrical connector (not shown) can be engaged with the electrical connector 8.

A pair of grounding legs 32 extend from a lower end of each side wall and are adapted for positioning on a printed circuit board to connect the outer shell 30 to the grounding terminal of the printed circuit board. The grounding legs 32 are spaced apart from each other along the length of the respective side wall.

The outer shell 30, including the grounding legs 32, is preferably made of stainless steel because it is a lost-cost material, has high anti-oxidation properties, high spring force/resiliency and high insertion durability. Because stainless steel cannot be easily soldered, and in particular not easily soldered with a tin solder, the grounding legs 32 are treated as described herein to enable the grounding legs 32 to be tin soldered to the printed circuit board. If desired, the remainder of the outer shell 30 can be treated in the same manner as described herein.

A plurality of retaining spring strips 31 are provided in the top wall and the side walls of the outer shell 30. Each retaining spring strip 31 is formed by stamping a portion of the outer shell such that each retaining spring strip 31 has an end integral with the outer shell 30 and a free end which protrudes into the interior of the outer shell 30. The retaining spring strips 31 are adapted to secure the mating electrical connector in engagement with the electrical connector 8.

The body 10 is attached to the rear wall of the outer shell such that it is substantially surrounded by the outer shell 30. This protects the electrical connector 8 against electromagnetic interference. The body 10 is preferably formed from plastic.

The terminals 20 are fixedly mounted on the body 10 and are positioned such that they contact and mate with respective terminals of the mating electrical connector. Each terminal 20 has one end extending from the bottom end of the body 10 and terminating in a leg 21 which extends through the opening in the bottom wall of the outer shell 30. The legs 21 are connected to a printed circuit board.

FIG. 4 illustrates a second embodiment of the electrical connector 8a. Like elements in the second embodiment of the connector 8a to that of the first embodiment of the connector 8 are denoted with like reference numerals and have the suffix “a” attached thereto.

The electrical connector 8a generally includes an electrically conductive outer shell 30a, an electrically insulative body 10a substantially surrounded by the outer shell 30a, and a set of metal terminals 20a which are mounted on the electrically insulative body 10a and extend outwardly from the outer shell 30a.

The outer shell 30a includes a rear wall 40a, a pair of side walls 41a, a top wall 42a, a bottom wall 43a and a front wall 44a. The front wall has an opening provided therein so that a mating electrical connector (not shown) can be engaged with the electrical connector 8a.

A pair of grounding legs 32a extend from a lower end of each side wall and are adapted for positioning on a printed circuit board (not shown) to connect the outer shell 30a to the grounding terminal of the printed circuit board. The grounding legs 32a are spaced apart from each other along the length of the respective side wall.

Identical to the first embodiment, the outer shell 30a, including the grounding legs 32a, is preferably made of inexpensive stainless steel. Because stainless steel cannot be easily soldered, the grounding legs 32a are treated as described herein to enable the grounding legs 32a to be soldered to the printed circuit board. If desired, the remainder of the outer shell 30a can be treated in the same manner as described herein.

The body 10a is mounted within the outer shell 30a such that it is substantially surrounded by the outer shell 30a. This protects the electrical connector 8a against electromagnetic interference. The body 10a is preferably formed from plastic.

The terminals 20a are fixedly mounted within the body 10a and are positioned such that they contact and mate with respective terminals of the mating electrical connector. Each terminal 20a has one end extending from the bottom end of the body 10a and terminating in a leg 21a which extends through the opening in the bottom wall of the outer shell 30a. The legs 21a are connected to a printed circuit board (not shown).

In a first method of treating the grounding legs 32, 32a, each stainless steel grounding legs 32, 32a is coarsened, preferably by acid cleaning using a suitable apparatus (not shown). Thereafter, the grounding legs 32, 32a are coated with a metal coating 34, 34a, such as by electroplating, using a suitable apparatus (not shown), such that a coarse metallic surface is provided on the grounding legs 32, 32a. The metal coating 34, 34a can preferably be nickel, tin, or lead. The coarse surface enables easy soldering, such as with a tin solder, of the grounding legs 32, 32a with a printed circuit board.

In a second method of treating the grounding legs 32, 32a, each stainless steel grounding leg 32, 32a is coated with a metal coating 34, 34a, preferably by electroplating, using a suitable apparatus (not shown). Thereafter, the metal coating 34, 34a is coarsened, preferably by acid cleaning, using a suitable apparatus (not shown) to provide a coarse surface on the grounding legs 32, 32a. The metal coating 34, 34a can preferably be nickel, tin, or lead. The coarse surface enables easy soldering, such as with a tin solder, of the grounding legs 32, 32a with a printed circuit board.

Because the outer shell 30, 30a is not electroplated except the grounding legs 32, 32a, most of the surface of the outer shell 30, 30a is kept smooth and has high anti-oxidation characteristics. If desired, however, the entire outer shell 30, 30a can be coarsened by acid cleaning and thereafter coated with the metal coating 34, 34a by electroplating such that a coarse metallic surface is provided on the entire outer shell 30, 30a, including the grounding legs 32, 32a, or the entire outer shell 30, 30a can be coated with a metal coating 34, 34a by electroplating and thereafter coarsened by acid cleaning such that a coarse metallic surface is provided on the entire outer shell 30, 30a, including the grounding legs 32, 32a.

With regard to the first embodiment of the electrical connector 8, because of the high resiliency of stainless steel of which the retaining spring strips 31 are made, less insertion resistance is produced when fastening the electrical connector 8 to the mating electrical connector. In addition, because stainless steel has high resiliency, when the retaining spring strips 31 are engaged against the mating electrical connector, the connection is secure. As a result, the electrical connector 8 is durable in use.

While preferred embodiments of the present invention are shown and described, it is envisioned that those skilled in the art may devise modifications of the present invention without departing from the spirit and scope of the appended claims.

What is claimed is:

1. An electrical connector comprising:
an outer shell including a grounding leg provided thereon, the outer shell being formed of a conductive material, the grounding leg being formed of stainless steel; and
a metal coating provided on the grounding leg, the metal coating having a coarse surface.

2. The electrical connector as defined in claim 1, wherein the metal coating is at least one of nickel, tin, and lead.

3. The electrical connector as defined in claim 1, wherein the metal coating is applied to the grounding leg, and wherein the coarse surface of the metal coating is formed by acid cleaning the grounding leg prior to applying the metal coating to the grounding leg.

4. The electrical connector as defined in claim 3, wherein the metal coating is deposited on the grounding leg by electroplating.

5. The electrical connector as defined in claim 1, wherein the coarse surface of the metal coating is formed by acid cleaning the metal coating.

6. The electrical connector as defined in claim 1, wherein the coarse surface of the metal coating is formed by depositing the metal coating on the grounding leg by electroplating and thereafter, acid cleaning the metal coating.

7. The electrical connector as defined in claim 1, wherein the outer shell is stainless steel.

8. An outer shell for an electrical connector comprising:
a plurality of panels defining an interior cavity for receiving a housing, the panels being made of a conductive material;
a grounding leg extending from one of the panels, the grounding leg being formed of stainless steel; and
a metal coating provided on the grounding leg, the metal coating having a coarse surface.

9. The outer shell as defined in claim 8, wherein the metal coating is at least one of nickel, tin, and lead.

10. The outer shell as defined in claim 8, wherein the metal coating is applied to the grounding leg, and wherein the coarse surface of the metal coating is formed by acid cleaning the grounding leg prior to applying the metal coating to the grounding leg.

11. The outer shell as defined in claim 10, wherein the metal coating is deposited on the grounding leg by electroplating.

12. The outer shell as defined in claim 8, wherein the coarse surface of the metal coating is formed by acid cleaning the metal coating.

13. The outer shell as defined in claim 8, wherein the coarse surface of the metal coating is formed by depositing the metal coating on the grounding leg by electroplating and thereafter, acid cleaning the metal coating.

14. The outer shell of claim 8, wherein the panels are made of stainless steel.

15. A method of preparing an electrical connector for soldering comprising the steps of:
(a) providing an electrical connector comprising a conductive outer shell having a grounding leg provided thereon, the grounding leg being formed of stainless steel;
(b) coarsening the grounding leg; and
(c) coating the coarsened grounding leg with a metal coating.

16. A method as defined in claim 14, wherein step (b) is performed by acid cleaning the grounding leg.

17. A method as defined in claim 14, wherein step (c) is performed by electroplating the metal coating on the grounding leg.

18. A method of preparing an electrical connector for soldering comprising the steps of:
(a) providing an electrical connector comprising a conductive outer shell having a grounding leg provided thereon, the grounding leg being formed of stainless steel;
(b) coating the grounding leg with a metal coating; and
(c) coarsening the metal coating.

19. A method as defined in claim 18, wherein step (b) is performed by electroplating the metal coating on the grounding leg.

20. A method as defined in claim 18, wherein step (c) is performed by acid cleaning the metal coating.
